(19) United States
(12) Patent Application Publication
(10) Pub. No.: US 2015/0033777 A1
(43) Pub. Date: Feb. 5, 2015

(54) HEAT PUMP, IN PARTICULAR FOR HEATING A VEHICLE INTERIOR, AND METHOD FOR OPERATING A HEAT PUMP

(71) Applicant: MAN Truck & Bus AG, Muenchen (DE)

(72) Inventor: Alexander SCHYDLO, MUENCHEN (DE)

(21) Appl. No.: 14/336,170

(22) Filed: Jul. 21, 2014

(30) Foreign Application Priority Data
Aug. 2, 2013 (DE) 10 2013 012 926.5

(51) Int. Cl. B60H 1/32; F25B 41/00; C09K 5/04; F25B 30/02

(52) U.S. Cl. CPC B60H 1/3213; F25B 30/02; F25B 41/00; C09K 5/041; F25B 2341/0011
USPC 62/112; 62/324.6; 62/500; 62/503; 62/115

(57) ABSTRACT

A heat pump for heating a vehicle interior includes a compressor arranged in a heat-pump circuit of a working medium, a condenser, a throttle valve and an evaporator. Gaseous working medium is compressed in the compressor. The compressor outlet is connected to the inlet of the condenser in which the working medium condenses, at the same time discharging heat, the heat being delivered as useful heat directly or indirectly to a consumer. The condenser is followed by a jet pump, to which the liquid working medium coming from the condenser is delivered as driving medium and to which the gaseous working medium flowing out from the evaporator is delivered as suction medium, in such a way that the driving medium and suction medium are compressed in the jet pump as a two-phase mixture. The jet-pump outlet is connected to the inlet of a separator, to which the two-phase mixture is delivered and in which the gaseous working medium is separated from the liquid working medium. The gas outlet of the separator is connected to the compressor inlet and the liquid outlet of the separator is connected to the inlet of the throttle valve, the liquid working medium being throttled in the throttle valve, and the outlet of the throttle valve is connected to the inlet of the evaporator, in which, by the supply of heat, phase transformation takes place to the gaseous working medium.

### CROSS REFERENCE TO RELATED APPLICATION

This Application claims the priority of German patent application No. 10 2013 012 926.5, filed Aug. 2, 2013.

### BACKGROUND OF THE INVENTION

The invention relates to a heat pump, in particular for heating a vehicle interior and to a method for operating a heat pump.

For the generation of cold and heat, a compression-cold-vapour-cycle is generally known, the working medium (refrigerant) used being hydrocarbons according to DIN 8962. For the heating of vehicle interiors, for example of passenger spaces of buses or driver's cabs, heat pumps are already used, in which a counter clockwise compression-cold-vapour cycle is implemented, the refrigerant often employed being R 134a.

In such a heat-pump circulatory process, a compressor, a condenser, a throttle valve and an evaporator are arranged in succession. The working medium (refrigerant) as superheated fluid is compressed in the compressor and is delivered to the condenser which discharges latent and sensible heat directly into a vehicle interior or transfers it indirectly to a secondary circuit as useful heat. After gas-to-liquid phase transformation in the condenser, the working medium is throttled in the following throttle valve by the Joule-Kelvin effect and at the end of the throttling process achieves the wet-steam parameters. Liquid-to-gas phase transformation takes place in the following evaporator, for which purpose heat is delivered to the evaporator from the surroundings.

The thermal efficiency of this known heat-pump circulatory process is dependent upon the compressor power and requires relatively high drive energy.

### SUMMARY OF THE INVENTION

The object of the invention is to develop a heat pump and a method for operating a heat pump such that the consumption of drive energy for the compressor is comparatively lower and therefore thermal efficiency is increased.

By the heat pump according to the invention, gaseous working medium is compressed in the heat-pump circuit in the compressor, and the compressed working medium is delivered to a condenser in which it condenses, at the same time discharging heat. Heat occurring there is delivered as useful heat directly or indirectly to at least one consumer, in particular a passenger interior.

The heat-pump circuit according to the invention is supplemented by further functional elements and modified with respect to the known heat-pump circuit. Thus, the condenser is followed by a jet pump, to which, on the one hand, the largely liquid working medium coming from the condenser at high pressure is delivered as driving medium by a drive nozzle. The term “jet pump” stands here, by way of example, for any device in which the pumping action is generated by fluid jet (“driving medium”) which by pulse exchange sucks in another medium (“suction medium”), accelerates it and compresses/conveys it in so far as it is under sufficient pressure.

On the other hand, the largely gaseous working medium flowing out from an evaporator at a lower pressure is delivered as suction medium. In this case, the overall medium composed of driving medium and suction medium is compressed to a two-phase mixture in the jet pump, preferably in the diffuser of the jet pump.

The jet-pump outlet is followed by a separator in which the gaseous working medium is separated from the liquid working medium.

The gas outlet of the separator is connected to the compressor inlet and the liquid outlet of the separator is connected to the inlet of the throttle valve. In the throttle valve, the largely liquid working medium is throttled and is delivered to the evaporator where, by the supply of heat, phase transformation takes place to a gaseous working medium which is delivered as suction medium to the suction-medium inlet of the jet pump.

The use according to the invention of the jet pump in the circulatory process comparatively reduces the compression work of the compressor and therefore advantageously leads to an increase in thermal efficiency. A lower drive energy consumption of the heat pump therefore leads to an increase in the overall thermodynamic efficiency in the drive train of a vehicle, in particular of a bus, and consequently leads to an energy-saving reduction in fuel consumption and to an environmentally friendly reduction in CO₂ emission.

An advantageous development of the heat-pump circuit according to the invention has an intermediate heat exchanger, by means of which, on the one hand, the working medium is conducted from the condenser to the jet pump and, on the other hand, the working medium is conducted from the separator to the compressor. Associated heat regeneration advantageously leads to a reduction in the exergy losses in the circuit.

Pressure levels must be stipulated for the heat-pump circuit in such a way that the highest pressure level is determined by the outlet pressure of the compressor and the lowest pressure level is determined by the saturation temperature in the evaporator. Two intermediate additional pressure levels arise as a result of the operating pressures downstream of the jet pump and downstream of the throttle valve.

The heat-pump circuit of the heat pump according to the invention can advantageously be operated with a working medium composed of carbon dioxide—CO₂ (designation R 744). This natural working medium is environmentally friendly and cost-effective, and the positive thermodynamic properties of carbon dioxide allow effective use in the heat pump. Moreover, ecological aspects are becoming increasingly relevant (for example, Directive 2006140/EC of the European Parliament and Council) and can be fulfilled by carbon dioxide—CO₂ as working medium.

The advantages which can be achieved by means of the procedure according to the invention correspond to those of the heat pump.

### BRIEF DESCRIPTION OF THE DRAWINGS

In the drawings:

FIG. 1 shows a schematic illustration of a CO₂ heat pump within an ejector as jet pump and with a compressor,

FIG. 2 shows an Inp-h graph of the counterclockwise CO₂ heat-pump circuit of the heat pump according to FIG. 1,

FIG. 3 shows a T-s graph to illustrate the saving of compression work,

FIG. 4 shows a schematic diagram of a heat pump without a jet pump according to prior art, and

FIG. 5 shows the Inp-h graph for the counterclockwise heat-pump circuit without a jet pump of the prior art heat pump according to FIG. 4.

### DETAILED DESCRIPTION OF THE PREFERRED EMBODIMENTS

FIG. 4 illustrates the diagram of a counterclockwise compression-cold-vapour-cycle process (KKKP) of a heat pump without a jet pump according to the prior art (the reference symbols used are intended to characterize both the connecting lines and the working medium in each case contained therein, together with its current states):

The working medium (refrigerant) is compressed in a known way as superheated fluid in the compressor V′ (polytropic compression 1′→2′) and is delivered to the condenser KON′. The latent and sensible heat of the fluid is transferred (2′→3′) in the condenser KON directly to a vehicle interior, for example a passenger space or a cab, or indirectly to a secondary medium circuit of the vehicle as useful heat. After phase transformation in the condenser KON′, the working medium is throttled in a following throttle valve DV′ (by the Joule-Kelvin effect 3′→4′). At the end of the throttling process, the working medium achieves the wet-steam parameters. The two-phase mixture is then delivered to an evaporator VER′. Phase transformation takes place in the evaporator, a heat stream delivered to the surroundings being transferred (4′→1′) with high thermodynamic potential to the working medium in the evaporator.

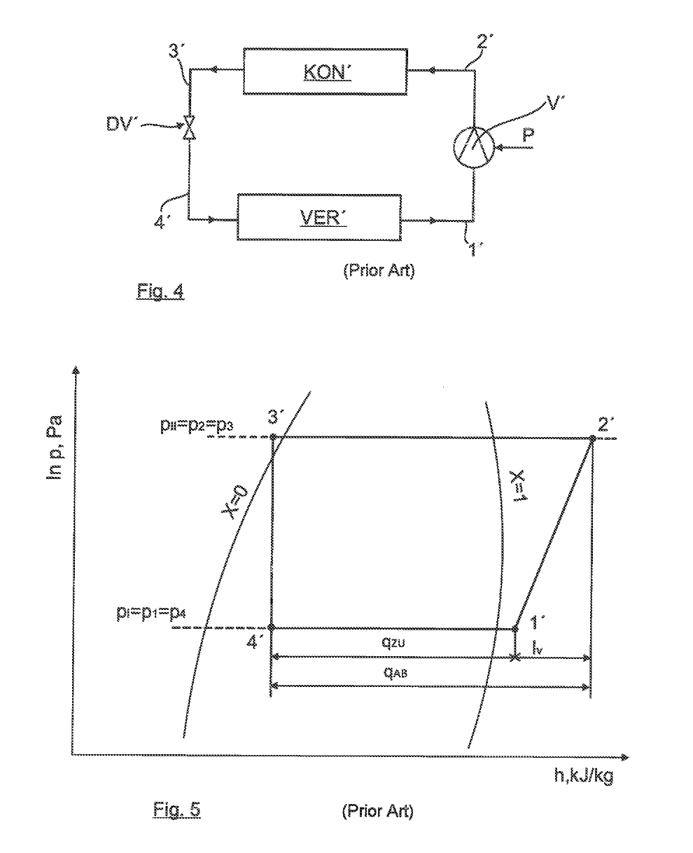

This known circuit according to the prior art is depicted in the pressure-enthalpy (Inp-h) graph of FIG. 5. The pressure level p_{I}=p₁p₄ corresponds to the pressure at the points 1′ and 4′ and the pressure level p_{II}=p₂=p₃ corresponds to the pressure level at the points 2′ and 3′. The pressure losses in the heat exchangers are negligible. The discharged heat q_{ab} can be gathered from the graph, this value corresponding to the supplied heat q_{zu}, supplemented by the compression work Iᵥ. The thermal efficiency is dependent upon the compressor power and the demand for drive energy rises with an increasing pressure ratio p_{II}/p_{I}.

The aim of the invention is to improve the above heat-pump circuit with an increase in thermal efficiency by a reduction in the consumption of drive energy for the compressor V. Moreover, environmentally friendly and inexpensive carbon dioxide—CO₂ (R 744) is used as a natural working medium (refrigerant).

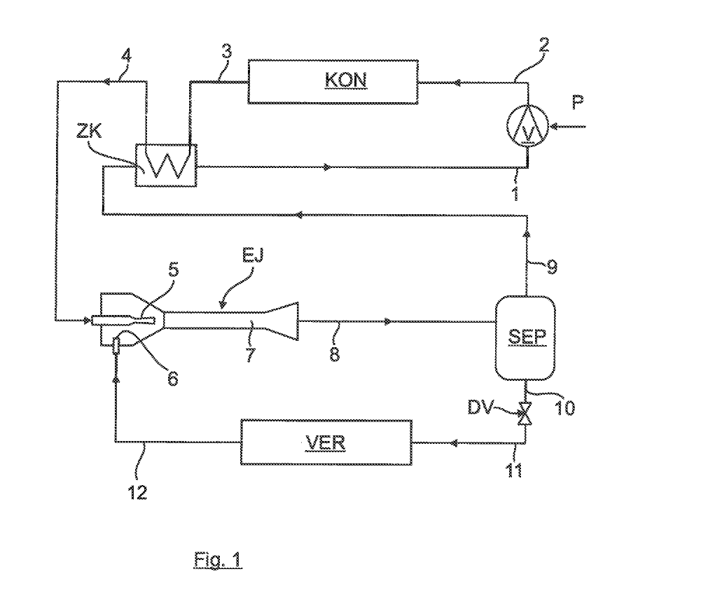

FIG. 1 illustrates the diagram of a CO₂ heat pump according to the invention with an ejector EJ as a jet pump and a compressor V. The compressor V is followed by a condenser KON via a line 2. The outlet of the condenser KON is connected via a line 3 to an intermediate heat exchanger ZK, the outlet of which is connected by means of a line 4 to a drive nozzle 5 of an ejector EJ. The outlet of the ejector EJ at the diffuser 7 leads by means of a line 8 to a separator SEP, the gas outlet of which is led via a line 9 to the intermediate heat exchanger ZK and from there by means of a line 1 to the inlet of the compressor V. The liquid outlet of the separator SEP is connected by means of a line 10 via a throttle valve DV and a line 11 to an evaporator VER, the outlet of which is led via a line 12 to a suction-medium inlet 6 of the ejector EJ.

The above arrangement has the following function:

The gaseous working medium CO₂ is compressed (1→2) in the compressor V. The working medium CO₂ is subsequently delivered to the condenser KON where phase transformation (2→3) takes place, in which the gaseous fluid condenses and the heat thereby occurring is available as useful heat. This can be transferred directly into a passenger space and/or a cab and/or another interior of a vehicle. Alternatively or in parallel, the useful heat may also be delivered to a heat circuit of the vehicle and utilized indirectly.

In the intermediate heat exchanger ZK, heat regeneration takes place (3→4, 9→1), which leads to the reduction in the exergy losses in the circuit. In this case, the working medium mass flow at the outlet from the condenser KON is cooled in the intermediate heat exchanger ZK, and, in countercurrent, the working medium mass flow is superheated upstream of the compressor V.

The working medium mass flow coming from the condenser is delivered from the intermediate heat exchanger ZK to the ejector EJ as driving medium at a drive nozzle 5 where the static pressure of the working medium fluid decreases. The decrease in static pressure in the ejector Ed increases the velocity of the working medium fluid in its cross section and leads to a local rise in dynamic pressure. This brings about the effect of a jet pump, so that another medium is sucked in and pumped as suction medium by the driving medium (fluid stream from the condenser KON or from the intermediate heat exchanger ZK). The suction medium hers is the working medium which flows out of the evaporator VER and which is connected via the line 12 to a suction-medium inlet 6 of the ejector EJ. At the end of the ejector EJ, in its diffuser 7, the overall medium is compressed. The ejector EJ as a pump has a very simple set-up and contains no moving parts, so that it can be used in an especially robust way and with low maintenance.

The compressed two-phase mixture from the ejector EJ is delivered to the separator SEP via the line 8. In the separator SEP, the gaseous CO₂ is separated from the liquid CO₂. The gaseous CO₂ flows out of the separator SEP via the line 9 to the intermediate heat exchanger ZK and from there further on via the line 1 to the compressor V.

Liquid CO₂ collects in the separator and is delivered via the line 10 by means of the throttle valve DV and the subsequent line 11 to the evaporator VER. In the evaporator, liquid-to-gas phase transformation is implemented, a heat stream being delivered to the liquid CO₂. The then gaseous CO₂ flows from the evaporator VER via the line 12 as suction medium to the ejector EJ.

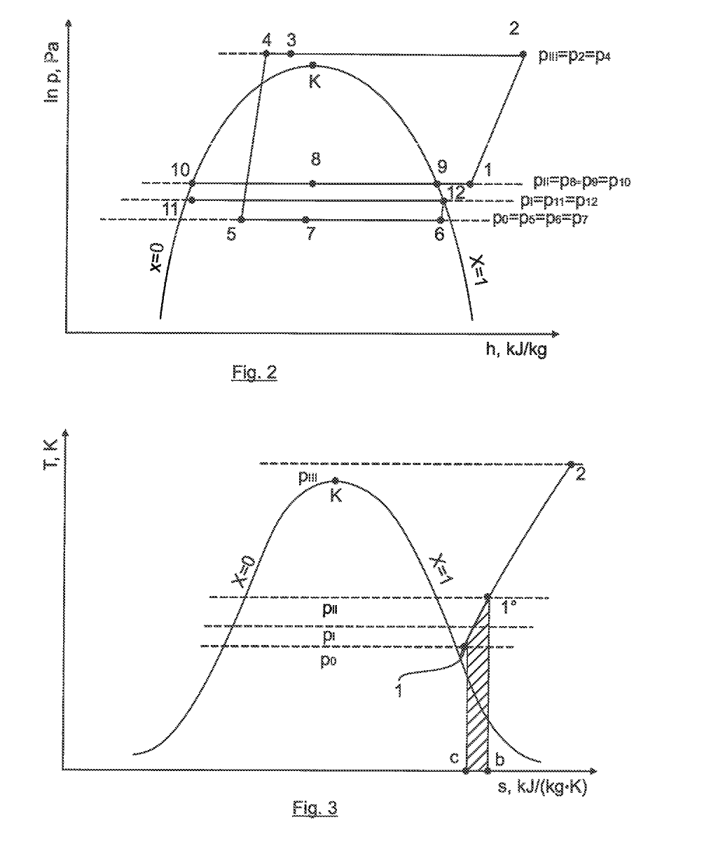

FIG. 2 illustrates the circulatory process in detail in an Inp-h graph:

To implement the CO₂ circulatory process, four pressure levels are defined. The highest pressure level defines the outlet pressure of the compressor V which, in the design phase of the heat pump, is dependent upon the saturation temperature of the fluid in the condenser KON, in such a way that the saturation temperature in the condenser KON must be higher than the temperature of the heat sink. The lowest pressure p₀ in the system lies at the saturation temperature in the evaporator VER corresponding to the temperature of the heat source. The two intermediate additional pressure levels p_{I} and p_{II} arise as resultant operating pressures downstream of the ejector EJ (compression at 8) and downstream of the throttle valve DV (at 11). These pressures are dependent upon the geometry and structural properties of the ejector EJ.

FIG. 3 characterizes the compression work of the compressor V for the two heat-pump concepts illustrated: the transition from 1 to 2 is for a heat pump without an ejector corresponding to the prior art according to FIGS. 4 and 5. The transition from 1⁰ to 2 is obtained for a heat pump according to the invention with an ejector EJ. It is shown that the compression work for the heat-pump concept with an ejector EJ is lower, as compared with a heat pump without an ejector EJ. The saving of compression work is identified in the temperature-entropy (T-s) graph of FIG. 3 by the hatched area 1→1⁰→b→c.

### List of reference symbols

V Compressor
KON Condenser
DV Throttle valve
VER Evaporator
ZK Intermediate heat exchanger
EJ Ejector
SEP Separator
1 Working medium (line) between ZK and V
2 Working medium (line) between V and KON
3 Working medium (line) between KON and ZK
4 Working medium (line) between ZK and EJ
5 Drive nozzle
6 Suction-medium inlet
7 Diffuser
8 Working medium (line) between EJ and SEP
9 Working medium (line) between SEP and ZK
10 Working medium (line) between SEP and DV
11 Working medium (line) between DV and VER
12 Working medium (line) between VER and EJ
1′ Working medium (line) between VER' and V′
2′ Working medium (line) between V′ and KON′
3′ Working medium (line) between KON' and DV′
4′ Working medium (line) between DV' and VER′

I claim:

1. A heat pump with a heat-pump circuit comprising:
a working medium routed in the heat-pump circuit;
a compressor for compressing the working medium;
a condenser for condensing the working medium and discharging heat, the heat being delivered as useful heat to a consumer;
a throttle valve having an inlet and an outlet;
an evaporator having an inlet receiving the working medium from the outlet of the throttle valve and for carrying out a phase transformation of the working medium to a gaseous form by the supply of heat;
a jet pump for receiving the working medium in a liquid form as a driving medium from the condenser and for receiving the working medium in the gaseous form as a suction medium from the condenser, the jet pump having a diffuser for compressing the driving medium and the suction medium in a two-phase mixture; and
a separator for receiving the two-phase mixture from the jet pump and separating the gaseous form of the working medium from the liquid form of the working medium, the separator having a gas outlet connected to an inlet of the compressor, and a liquid outlet connected to the inlet of the throttle valve.

2. The heat pump of claim 1, wherein the heat pump is for heating a vehicle interior and the consumer to which heat is delivered is the vehicle interior.

3. The heat pump of claim 1, further comprising an intermediate heat exchanger conducting working medium from the condenser to the jet pump and conducting medium from the separator to the compressor.

4. The heat pump of claim 1, wherein the heat-pump circuit has four pressure levels including:
a highest pressure level determined by an outlet pressure of the compressor,
a lowest pressure level determined by a saturation temperature in the evaporator;
a first intermediate pressure level determined by an operating pressure downstream of the jet pump; and
a second intermediate pressure level determined by an operating pressure downstream of the throttle valve.

5. The heat pump of claim 1, wherein the working medium is carbon dioxide—CO₂ (R 744).

6. A method of operating a heat pump with a heat-pump circuit including a working medium routed in the heat-pump circuit; a compressor for compressing the working medium; a condenser for condensing the working medium and discharging heat, the heat being delivered as useful heat to a consumer; a throttle valve having an inlet and an outlet; an evaporator having an inlet receiving the working medium from the outlet of the throttle valve and for carrying out a phase transformation of the working medium to a gaseous form by the supply of heat; a jet pump for receiving the working medium in a liquid form as a driving medium from the condenser and for receiving the working medium in the gaseous form as a suction medium from the condenser, the jet pump having a diffuser for compressing the driving medium and the suction medium in a two-phase mixture; and a separator for receiving the two-phase mixture from the jet pump and separating the gaseous form of the working medium from the liquid form of the working medium, the separator having a gas outlet connected to an inlet of the compressor, and a liquid outlet connected to the inlet of the throttle valve,
the method comprising the steps of:
compressing the working medium in the compressor;
delivering the compressed working medium from the compressor to the inlet of the condenser;
condensing the working medium in the condenser, discharging heat, and delivering the heat has useful heat to at least one consumer;
delivering the working medium from the output of the condenser to the ejector pump as the driving medium;
delivering the working medium from the output of the evaporator to the ejector pump as the suction medium;
compressing the driving medium and the suction medium in the diffuser of the ejector pump as a two-phase mixture;
delivering the two-phase mixture to the separator and separating the gaseous form of the working medium from the liquid form of the working medium in the separator;
delivering the gaseous form of the working medium from the separator to the compressor;
delivering the liquid form of the working medium from the separator to the throttle valve and throttling the liquid form of the working medium from the separator in the throttle valve; and
delivering the throttled liquid form of the working medium from the throttle valve to the evaporator.

7. A vehicle with a heat pump according to claim 2.
